(19) United States
(12) Patent Application Publication
(10) Pub. No.: US 2006/0292974 A1
(43) Pub. Date: Dec. 28, 2006

(54) Method of operating a change-over element of an exhaust system for vehicle

(75) Inventors: Juergen Schorn, Rutesheim (DE); Joerg Winkel, Weissach (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/474,357

(22) Filed: Jun. 26, 2006

(30) Foreign Application Priority Data
Jun. 27, 2005 (DE) 10 2005 029 763.3

(51) Int. Cl. B08B 15/02

(52) U.S. Cl. 454/63

(57) ABSTRACT

A method is provided for operating a change-over element of a motor vehicle exhaust system. The change-over element is moved into a first position or a second position, whereby a first or second flow path is adjusted in the exhaust system. For an optimized actuation of the change-over element from the first position into the second position and/or vice-versa, an open position and/or a closing position of a vehicle part is taken into account which at least partially bounds the vehicle occupant compartment.

This application claims the priority of DE 10 2005 029 763.3, filed Jun. 27, 2005, the disclosure of which is expressly incorporated by reference herein.

### BACKGROUND AND SUMMARY OF THE INVENTION

The present invention relates a method of operating a change-over element of an exhaust system for a motor vehicle.

DE 103 09 468 A1 describes a type-forming method of operating a change-over element of an exhaust system in a motor vehicle. The change-over element is a shut-off device in the form of a triggerable movable flap such that, in a first position, the flap takes up a pass position or, in a second position, it takes up a shut-off position, whereby at least two flow paths for the exhaust gas can be provided in the exhaust system. The triggering of the change-over element, thus, the operation of the flap from the shut-off position into the pass position and vice-versa, takes place as a function of a characteristic diagram or in a manually triggered manner according to the driver's intention.

DE 198 37 097 A1 discloses an exhaust system which has a disk valve change-over element. Depending on whether the disk valve takes up a pass or shut-off position, the exhaust gas flow coming from the internal-combustion engine is guided along a first or a second flow path.

In exhaust systems of this known type, the different flow paths are normally characterized by different exhaust back pressures and/or by different noise suppression features. Thereby, the exhaust systems, which are also called flap-type exhaust systems, can be used for improving the power of the internal-combustion engine and/or for providing two different exhaust gas sound patterns.

An object of the present invention is to provide an improved method of operating a change-over element of an exhaust system.

This object has been achieved by a method of operating a change-over element of an exhaust system on which the actuating of the change-over element from the first position into the second position and/or vice-versa, an open position and/or a closing position of a vehicle part is taken into account which at least partially bounds the vehicle occupant compartment.

Among the principal advantages achieved with the invention are that an exhaust system can be operated such that, independently of the position of a vehicle part bounding the occupant compartment, an optimized sound pattern can be heard in the occupant compartment.

It was found that the sound patterns caused by the exhaust gas flow may carry undesirable ambient noise which is heard differently inside the occupant compartment, specifically depending on whether the vehicle part bounding the vehicle occupant compartment is present in an open or closing position. If the vehicle part bounding the vehicle occupant compartment is at least partially opened, sounds penetrate from the outside into the vehicle occupant compartment; for example, wind noise during the drive, noise from other vehicles or other environmental sounds, which may at least partially mask or cancel the ambient noise generated by the exhaust gas flow, so that these sounds are not heard or are heard in a suppressed manner.

If the vehicle part is closed, the ambient noise can be heard in an intensified fashion. The ambient sounds generated by the exhaust gas flow always exist as a function of the rotational speed and/or the load condition of the internal-combustion engine and as a function of the flow path adjusted by the shut-off device, but their loudness as perceived by the driver will vary, depending on whether the vehicle occupant compartment is partially opened or closed. Corresponding to the position of the change-over element, the respectively favorable flow path is selected by the method of the present invention as a function of the position of the vehicle part.

The triggering according to the invention as a function of the position of the vehicle part bounding the vehicle occupant compartment can be superimposed in a further development on the conventional triggering of the change-over element, for example, as a function of the rotational speed, of the load condition or similar operating parameters of the transmission line, particularly of the vehicle engine or a driver's intention.

According to a further development, this inventive method can be implemented in a particularly simple manner. In most vehicles, operating parameters of the transmission line are already detected. These include, for example, the rotational speed and the load condition of the internal-combustion engine, the engaged gear of the gearing of the transmission line or other operating parameters of the transmission line. The operating parameters which are detected anyhow can therefore be used for triggering the change-over element of the exhaust system.

Depending on the position of the vehicle part bounding the vehicle occupant compartment, different values of the same operating parameter are assigned to the open position and the closing position respectively of the vehicle part which is provided in a further development. Thus, for example, at a first rotational speed value, the change-over element may be displaced from the second position into the first position if the vehicle part is currently in the open position. At a second rotational speed value, the change-over element can be moved from the second position into the first position if the vehicle part takes up the closed position, the second rotational speed value being higher than the first rotational speed value. In other words: If the vehicle part bounding the vehicle occupant compartment is in the open position, the change-over element—relative to the rotational speed of the internal-combustion engine—is moved earlier from the second position into the first position than this would take place when the vehicle part is closed.

Instead of the rotational speed of the vehicle engine, as an alternative or in addition, the load condition of the vehicle engine can be used for triggering the change-over element. The load condition—like the rotational speed—can be determined in a simple manner, for example, by determining the position of the throttle valve, measuring the air mass penetrating the intake system of the internal-combustion engine or actually determining the torque provided by the internal-combustion engine. Of course, other determination methods can also be used for this purpose within the contemplation of the invention.

Corresponding to a further development of the invention, at a definable rotational-speed value of the vehicle engine, the change-over element is changed from the second position to the first position, particularly in the first position of the change-over element. A flow path is adjusted within the exhaust system and generates a lower exhaust back pressure than the back pressure present in the flow path when the change-over element is in the second position. The change-over element is moved from the first position back into the second position when the vehicle engine reaches a predefinable load condition. It was found that, at a high load, louder noise is also generated by the exhaust gas flow in the exhaust system. In order to avoid an excessive noise development, the change-over element is therefore displaced back into the second position.

The method according to the invention is particularly preferably used in the case of motor vehicles which have a movable roof element. This roof element can therefore be considered to be a vehicle part which bounds the vehicle occupant compartment at least partially. The movable roof element is therefore, for example, a retractable roof, as used in a convertible. As an alternative, the movable roof element may also be a sliding cover or a large-surface sliding roof, as used in the case of closed motor vehicles in the roof area. However, it is also contemplated that the vehicle part at least partially bounding the vehicle occupant compartment represents a window, such as a side window of the door or the like. The respective position of the vehicle part can easily be determined by known measures, particularly if the vehicle part is moved by a power drive.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cutout-type perspective view of an exhaust system of a motor vehicle;

FIG. 2 is a perspective view of a motor vehicle having a sliding top;

FIG. 3 is a perspective view of a convertible vehicle; and

FIG. 4 is a block diagram of a control of the exhaust system.

### DETAILED DESCRIPTION OF THE DRAWINGS

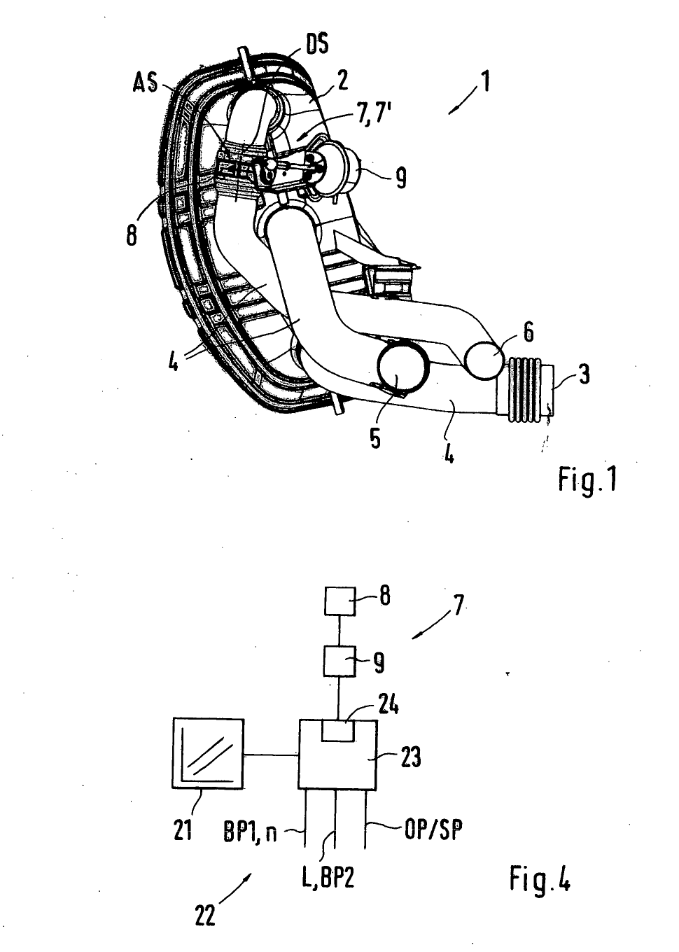

FIG. 1 illustrates a muffler 2 which is situated between an exhaust gas inlet (not shown) of an exhaust system designated generally by the numeral 1 and an exhaust gas outlet of the exhaust system 1. The muffler 2 is part of the partially illustrated exhaust system 1. The exhaust gas inlet is connected with an engine (not shown) of a transmission line of a motor vehicle.

The muffler 2 has an input 3 arranged behind the exhaust gas inlet, as viewed in the exhaust gas flow direction. The input 3 leads to the muffler 2 by way of a pipe 4. In addition, the muffler 2 has at least one output 5, preferably two outputs 5 and 6, which leads or lead to the outlet (not shown) of the exhaust system 1 and which is or are situated at the end of other pipes 4 which are connected with the muffler 2.

A change-over element 7 is arranged between the exhaust gas inlet and the exhaust gas outlet of the exhaust system 1. By way of the change-over element 7, depending on its first position or second position, two different flow paths for the exhaust gas can be adjusted between the exhaust gas inlet and the exhaust gas outlet. In the illustrated embodiment of FIG. 1, the change-over element 7 is arranged adjacent to the muffler 2 and preferably inside a pipe 4 which has the output 5 or 6.

In a currently preferred embodiment, the element 7 is constructed as a shut-off device 7′, for example, in the shape of a flap 8, arranged inside the pipe 4. This flap 8 is shown by solid lines in a shut-off position AS (second position) and by broken lines in a pass position DS (first position). Depending on whether the change-over element 7 takes up the shut-off position AS (or second position) or the pass position DS (or first position), the exhaust gas flowing by way of the input 3 into the muffler 2 reaches the output 5 or 6.

The above mentioned two flow paths for the exhaust gas are therefore provided by different exhaust gas paths within the muffler 2, in which case the corresponding flow path is adjusted corresponding to the position of the change-over element 7. A drive 9 is provided for moving the change-over element 7 into the shut-off position AS (second position) or into a pass position DS (first position).

The drive 9 and therefore the change-over element 7 are triggered, for example, as a function of at least one operating parameter of the transmission line of the vehicle (not shown) and which comprises at least the vehicle engine as the internal-combustion engine and a gearing. As an alternative or in addition, the triggering of the change-over element 7 can take place manually as a driver's intention by way of a key/switch.

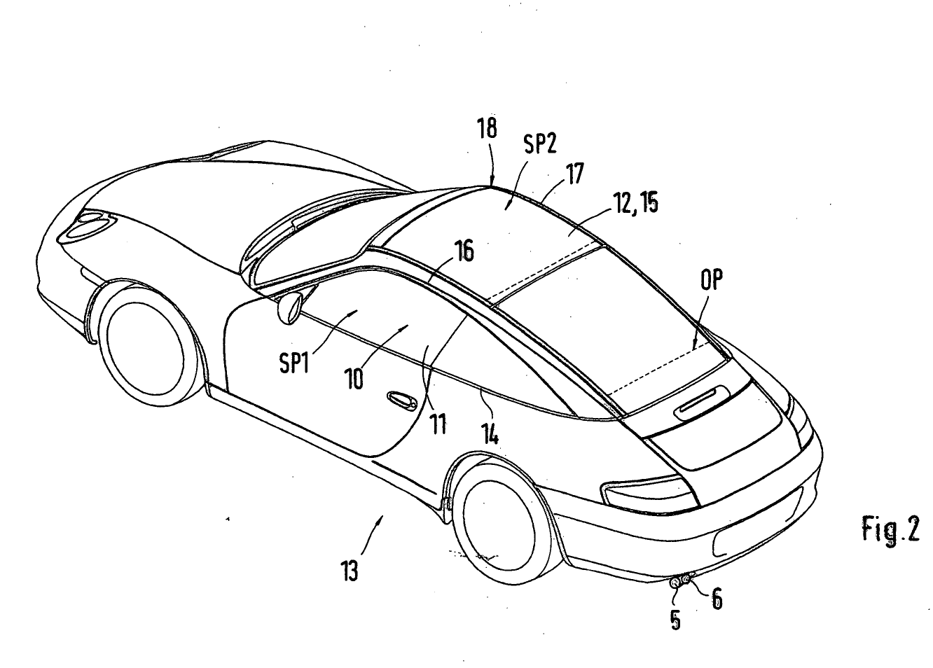

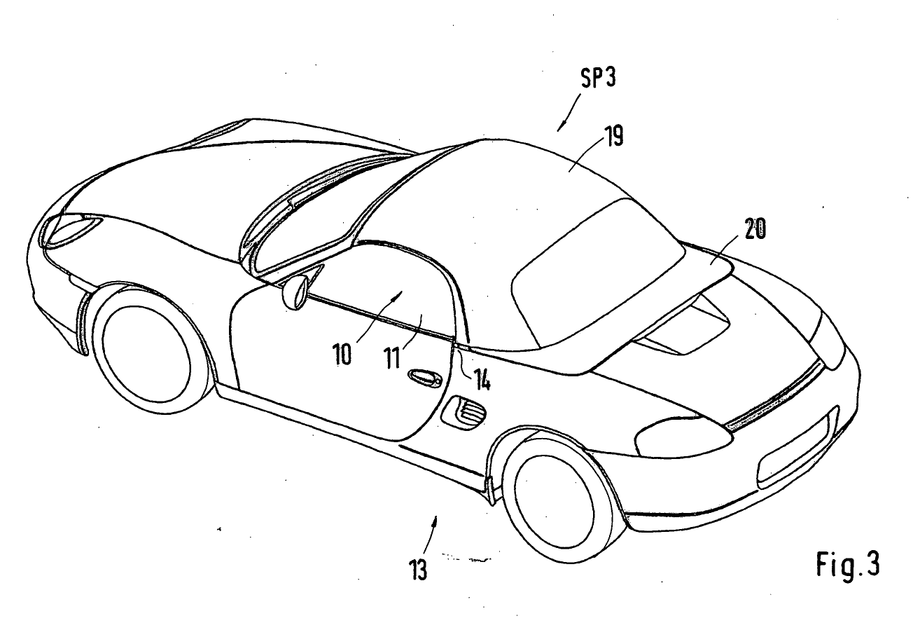

In addition, or as an alternative, the triggering of the change-over element 7 from the second position into the first position and vice-versa takes place as a function of a vehicle part 11, 12 of a motor vehicle 13 bounding a vehicle occupant compartment 10 (see FIGS. 2 and 3). The vehicle part 11 is, for example, a side window which, in the closing position SP1, is arranged above a belt line 14 and, in an open position (not shown) is situated at least partially below the belt line 14. Here, the vehicle part 12 is constructed as a large-surface sliding cover 15 which is displaceably arranged between two roof rails 16 and 17 and takes up its closing position SP2 marked by solid lines. The vehicle part 12, thus, the sliding cover 15, can be displaced into an open position OP indicated by broken lines, so that a roof opening 18 is at least partially opened. The vehicle parts 11, 12 are components of a skin of the body of the motor vehicle 13.

In the motor vehicle 13 illustrated in FIG. 3, a convertible top is provided as the vehicle part 19 bounding the vehicle occupant compartment 10 above the belt line 14, which convertible top is in the closing position SP3 in FIG. 3 and, in an open position (not shown), can be deposited completely in a folding top compartment (also not shown) and is situated below a folding top compartment lid 20. The vehicle part 19 in FIG. 3 and the vehicle part 12 in FIG. 2 form movable roof elements which can therefore be displaced into an open position OP and a closing position SP3 or SP2, respectively.

Depending on whether the vehicle parts 11, 12 and 19 take up their open position OP or their closing position SP1, SP2 or SP3, the flap 8 illustrated in FIG. 1 is displaced from the shut-off position AS into the pass position DS and vice-versa, so that the different flow paths can be adjusted as a function of the position of the vehicle parts 11, 12 and 19 and in function of an operating parameter of the transmission line.

The triggering of the change-over element 7 to move from the second position into the first position and vice-versa will be explained in detail in the following by way of a preferred embodiment with reference to FIG. 4. It is assumed here that the change-over element is constructed as the shut-off device 7′ which, in the position, takes up the pass position DS and, in the second position, takes up the shut-off position AS. In the pass position DS, the adjusted flow path has a lower exhaust gas back pressure and/or a lower muffling of noise than the other flow path which is adjusted when the shut-off position AS is set. It is also assumed that the vehicle part 19 is constructed as a folding top, as illustrated in FIG. 3.

The shut-off device 7′ is controlled as a function of a first operating parameter BP1 and of a second operating parameter BP2 of the transmission line. At a first value W1 of the first operating parameter BP1, the shut-off device 7′ is displaced from the shut-off position AS into the pass position DS, and, at a second value W2 of the second operating parameter BP2, is moved back from the pass position DS into the shut-off position AS. If the vehicle part 19 is in the open position OP, the assigned values are W1_{OP} and W2_{OP}, and for the closing position SP3 of the vehicle part 19, the corresponding values are W1_{SP} and W2_{SP}. The following applies to the triggering of the shut-off device 7′: W1_{OP}<W1_{SP} and W2_{OP}>W2_{SP}.

If it is now further assumed that the first operating parameter BP1 is the rotational speed n and the second operating parameter BP2 is the load condition L of the vehicle engine, the following will apply: n1 =W1_{OP}, n2 =W1_{SP}, L1=W2_{OP} and L2=W2_{SP}: n1<n2 and L1>L2. The values for controlling the change-over element 7 or the shut-off device 7′ may be filed in a so-called characteristic diagram 21, preferably having at least one characteristic curve, which diagram 21 is a component of a control device for the change-over element 7. As seen in FIG. 4, the control device 22 also has an analyzing unit 23 which detects the operating parameters BP1, BP2 as well as the open and/or closing position SP of the at least one vehicle part 11, 13, 19 and which supplies the drive 9 by way of a triggering unit 24.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Method of operating a change-over element of a motor vehicle exhaust system, whereby the change-over element is configured to be moved into a first position or a second position to adjust a first or second flow path in the exhaust system, comprising, upon actuating the change-over element from the first position into the second position and/or vice-versa, at least one of an open position and a closing position of a vehicle part which at least partially bounds a vehicle occupant compartment is taken into account.

2. Method according to claim 1, wherein, when the change-over element is actuated, at least one operating parameter of a transmission line of the vehicle is taken into account.

3. Method according to claim 1, wherein the actuating of the change-over element is effectuatable manually, including as the driver's intention.

4. Method according to claim 1, wherein, as a function of the open position and/or closing position, different values of the same operating parameter of the transmission line are usable for actuating the change-over element.

5. Method according to claim 4, wherein, when the change-over element is actuated, at least one operating parameter of a transmission line of the vehicle is taken into account.

6. Method according to claim 1, wherein the actuating of the change-over element from the second position into the first position and/or vice-versa, when the vehicle part is in the open position, takes place at a different value of an operating parameter than when the vehicle part is in the closing position.

7. Method according to claim 2, wherein a rotational speed of the vehicle engine is used as an operating parameter of the transmission line for actuating the change-over element.

8. Method according to claim 2, wherein a load condition of a vehicle engine of the transmission line is used as the operating parameter of the transmission lien for actuating the change-over element.

9. Method according to claim 2, wherein, at a given value of a first operating parameter of the transmission line, the change-over element is actuated from the second position into the first position, and, at a definable value of a second operating parameter of the transmission line, the change-over element is actuated from the first position into the second position.

10. Method according to claim 1, wherein a movable roof element is taken into account as the vehicle part in a open position thereof and/or a closing position thereof.

11. Method according to claim 1, wherein a shut-off device comprises the change-over element which, in the first position, takes up a pass position and, in the second position, takes up a shut-off position in one of the flow paths.
